(19) United States
(12) Patent Application Publication
(10) Pub. No.: US 2017/0215396 A1
(43) Pub. Date: Aug. 3, 2017

(54) FUNCTIONAL ORNAMENTATION, METHODS OF USE, AND METHOD OF MANUFACTURE

(71) Applicant: James E. Baker, JR., Kansas City, MO (US)

(72) Inventor: James E. Baker, JR., Kansas City, MO (US)

(21) Appl. No.: 15/422,228

(22) Filed: Feb. 1, 2017

Related U.S. Application Data
(60) Provisional application No. 62/289,544, filed on Feb. 1, 2016.

(51) Int. Cl. A01K 85/00; A01K 83/00

(52) U.S. Cl. CPC A01K 85/00; A01K 83/00

(57) ABSTRACT

A functional ornamentation manufactured from a stamped metal plate which is twisted by a specified number of degrees to result in a shape that allows for unique reactions to flowing fluids such as air and water. Due to the shape and twist of the device, the device will spin along with the flowing fluid or when pulled through that fluid, such that it retains a straight trajectory. In a preferred embodiment, such as part of a fishing lure, the ornamentation is connected to a ball bearing swivel which allows for near frictionless rotation. The lure when drawn through the water travels in a straight path, rather than an arced path of the prior art. This results in a more natural travel path producing greater flash and rotation for attacking fish.

### CROSS-REFERENCE TO RELATED APPLICATION

This application claims priority in U.S. Provisional Patent Application No. 62/289,544, filed Feb. 1, 2016, which is incorporated herein by reference.

### BACKGROUND OF THE INVENTION

1. Field of the Invention

The present invention relates generally to a functional ornamentation and method for use and manufacture thereof, and more specifically to a twisted metal ornamentation with functional features for fishing lures, jewelry, and general decoration.

2. Description of the Related Art

The prior art is manufactured typically by taking a square piece of metal, twisting the metal the appropriate amount of rotations, and then using a grinder and/or cutting tools to form the final shape of the functional ornamentation. This is a tedious and labor intensive process and requires a later step of painting the ornamentation, which is difficult once the ornamentation has been bent.

When used as part of a fishing lure, the prior art devices are limited to a single type of action, whether that is top of the water fishing, deep water fishing, or vertical jigging. Those intended for deep water fishing typically are confined to travel along a designed arc path, which is not ideal for fishing due to the unnatural path through the water.

The ornamentation of the prior art has similar issues when used in other fields, such as hanging ornamentation in chandeliers, wind chimes, or jewelry. The cost prohibitive nature of the manufacture of those elements only increases with the size and scale of the ornamentation. What is needed is a method of manufacturing a unique ornamentation device that not only offers superior functionality as a fishing lure, but has multitudes of other uses as well due to its unique shape.

Heretofore there has not been available a system or method for functional ornamentation with the advantages and features of the present invention.

### BRIEF SUMMARY OF THE INVENTION

The present invention generally provides a functional ornamentation manufactured from a stamped metal plate which is twisted by a specified number of degrees to result in a shape that allows for unique reactions to flowing fluids such as air and water. Due to the shape and twist of the device, the device will spin along with the flowing fluid or when pulled through that fluid, such that it retains a straight trajectory. In a preferred embodiment, such as part of a fishing lure, the ornamentation is connected to a ball bearing swivel which allows for near frictionless rotation. The lure can be used at the surface of the water, in deep water, or in a vertical jig orientation (e.g. ice fishing) with identical results. The lure when drawn through the water travels in a straight path, rather than an arced path of the prior art. This results in a more natural travel path producing greater flash and rotation for attacking fish. Elements may be affixed to the ornamentation or the fishing hook which knock against the ornamentation or spin out from the ornamentation for additional attraction of fish, including additional flash or noise.

The ornamentation may be used for multiple other purposes, including earrings and other jewelry, chandeliers, and wind chimes. A hanging decoration including a fan for moving air allows for multiple hanging elements of the present invention to spin freely with perfect vertical rotation. When design elements are painted, printed, or cut out from the ornamentation, those design elements produce unique images while the ornamentation is spinning freely. Painted or printed images of figures produce an optical illusion of a three-dimensional figure in the air as the ornamentation spins.

### BRIEF DESCRIPTION OF THE DRAWINGS

The drawings constitute a part of this specification and include exemplary embodiments of the present invention illustrating various objects and features thereof.

FIG. 1 is a three dimensional view of a first embodiment of the present invention.

FIG. 2 is a front elevational view of an embodiment of the present invention in an un-twisted orientation.

FIG. 3 is a front elevational view of a prior art embodiment thereof.

FIG. 4 is a front elevational view of the embodiment of FIG. 1.

FIG. 5 is a side elevational view thereof.

FIG. 6 is a front elevational view of a second embodiment of the present invention.

FIG. 7 is a side elevational view thereof.

FIG. 8 is a front elevational view of a third embodiment of the present invention.

FIG. 9 is a side elevational view thereof.

FIG. 10 is a front elevational view of the embodiment of FIG. 4 shown including a fishing hook.

FIG. 11 is a front elevational view of the embodiment of FIG. 6 shown including a fishing hook.

FIG. 12 is a front elevational view of the embodiment of FIG. 4 shown including a pair of tail elements attached by a chain.

FIG. 13 is a front elevational view of a fourth embodiment of the present invention in an un-twisted orientation.

FIG. 14 is a front elevational view thereof in a twisted orientation.

FIG. 15A is a side elevational view thereof.

FIG. 15B is a side elevational view thereof, showing connection with an external element.

FIG. 16 is a three dimensional isometric view thereof.

FIG. 17 is a front elevational view thereof, shown in connection with a sound-maker element.

FIG. 18 is a front elevational view of the sound-maker element as taken about the circle of FIG. 17.

FIG. 19 is a side elevational view thereof.

FIG. 20 is a front elevational view thereof, shown in an unbent orientation.

FIG. 21 is a front elevational view of an alternative embodiment of FIG. 14 including front and rear image elements.

FIG. 22 is a three-dimensional isometric view thereof.

FIG. 23A is a front elevational view of the embodiment of FIG. 8 including front and rear image elements.

FIG. 23B is a side elevational view of the embodiment of FIG. 9 including front and rear image elements.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The four embodiment ornamentations disclosed herein could be used for any type of ornamentation, from household decorations (e.g. Christmas tree ornaments or wind chimes) to pendants, earrings, or other body decorations, to functional ornamentations for use as fishing lures. The twisting of the ornamentations promotes the spinning of the orientation when in contact with a fluid, such as water or air.

### II. First Embodiment Functional Ornamentation 2

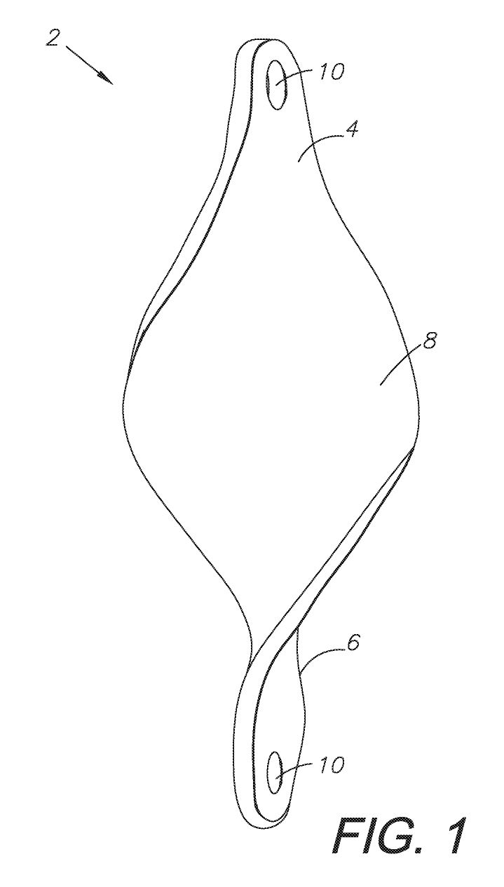

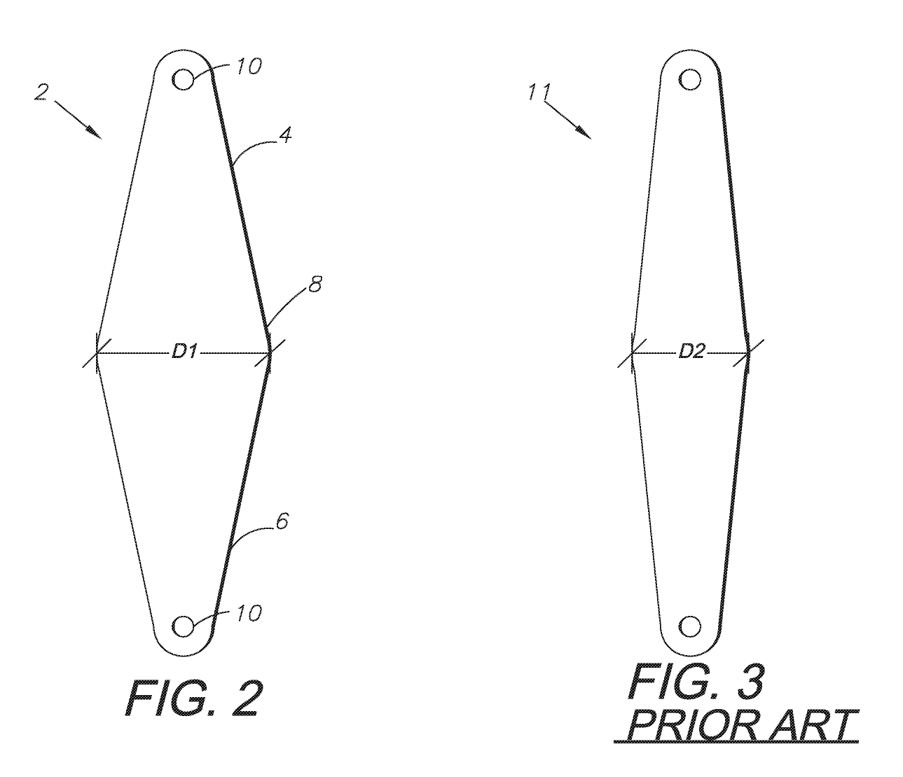

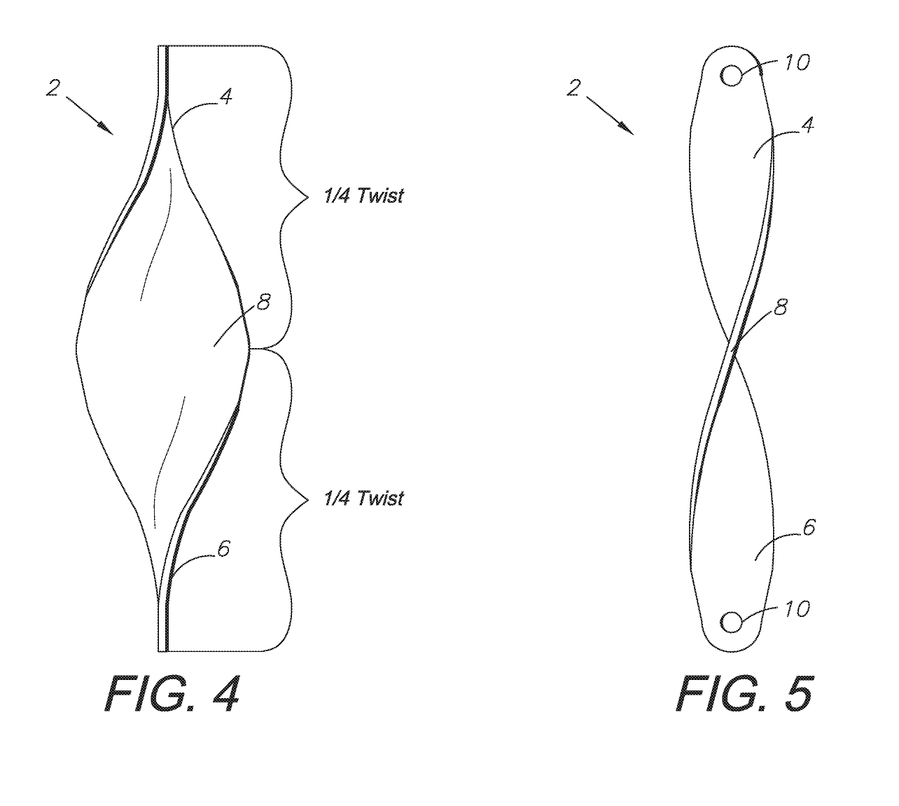

FIGS. 1, 2, 4-5, 10, and 12 show a first embodiment functional ornamentation 2. The present invention is manufactured from a stamped plate having rounded ends and a wider central diameter “D1” than the ends (see FIG. 2), which is in contrast to the most relevant prior art 11 (see FIG. 3), which has a much narrower central diameter “D2.” The widest point of the plate is approximately 36% as wide as the length of the plate, and the thinnest point of the plate at each end is approximately ⅓ of width of the center. The sides form an angle of approximately 150-155 degrees. Said another way—the central diameter D1 is between sixty percent (60%) and seventy-five percent (75%) of a length L, where D1 is the widest point of said main body blank, and where length L is the distance between a top-most point of said top end and a point along a line corresponding with said central diameter D.

The prior art, however, is only approximately 25% as wide as the length of the plate, and the thinnest point at each end only half as wide as the center. The angle formed is therefore approximately between 160-165 degrees. This variance lends a great deal of versatility to the present invention over the prior art.

FIGS. 1 and 4-5 show the first embodiment ornamentation 2 which includes two ¼ twists of the metal plate, resulting in a half twist or 180 degree twist of the entire blank. The piece can then be broken down to an upper end 4, a lower end 6, and the wide central portion 8. Each end 4, 6 has a mounting hole 10 for receiving connectors, such as linking rings 14 for fish hooks, fishing lures, earing hooks, or other items for connecting to the ornamentation 2. In this orientation, the upper 4 and lower 6 ends are perpendicular to the central portion 8.

To form this twist, and all of the various embodiments of the present invention, the blank as shown in FIG. 2 is heated, either using a torch or through some other method (e.g. running current through the blank), which allows the blank to become more malleable. At this stage, the blank can be twisted to the desired proportions. The blank is most likely made of brass, cold rolled steel, aluminum, or plastic. Twisting can be done by hand using a vice and vice grips or pliers, or could be performed by a machine.

No grinding or cutting of the blades is required. The punched template is heated and twisted into shape and the final product is then ready.

### III. Second Embodiment Ornamentation 52

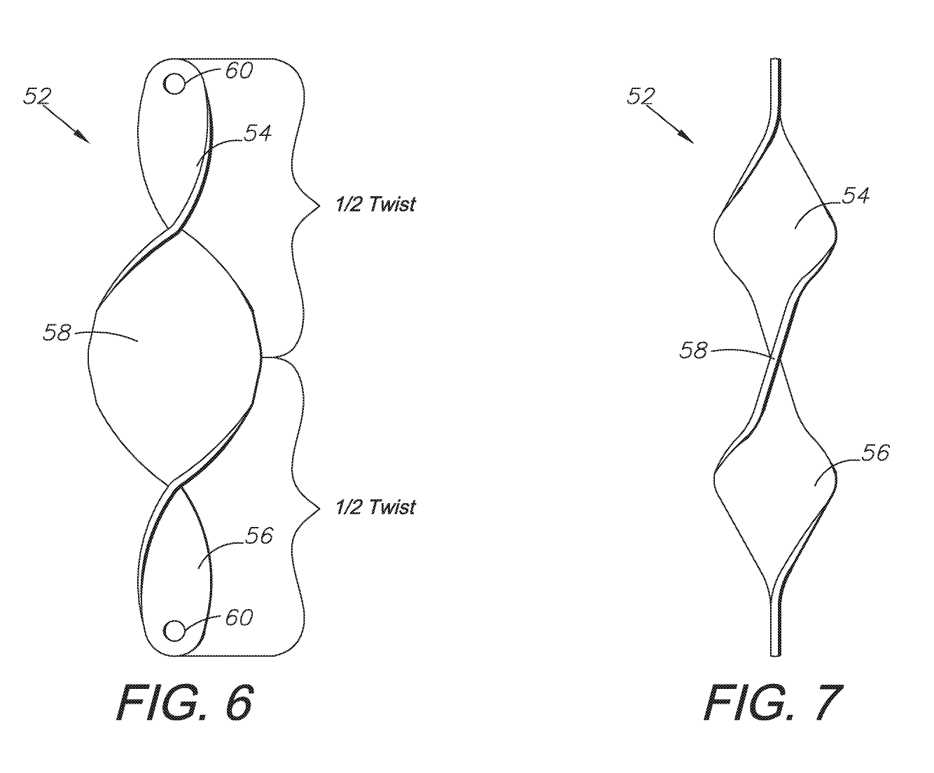

FIGS. 6 and 7 show a second embodiment ornamentation 52 which includes two ½ twists, or a full 360 degree twist of the entire blank. As before, this breaks the ornamentation 52 into a top portion 54, a bottom portion 56, and a central portion 58. The top and bottom portions include mounting holes 60.

### IV. Third Embodiment Ornamentation 102

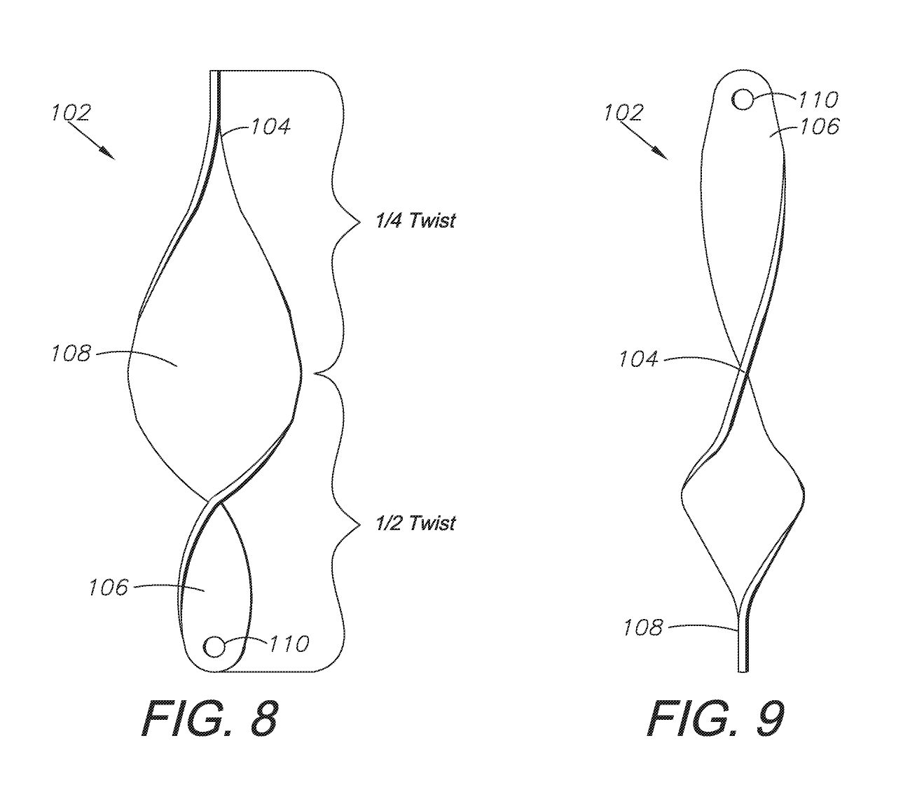

FIGS. 8 and 9 show a third embodiment ornamentation 102 which includes one ¼ twist on the top and one ½ twist on the bottom. Again, this separates the ornamentation 102 into a top portion 104, a bottom portion 106, and a central portion 108. The top and bottom portions include mounting holes 110.

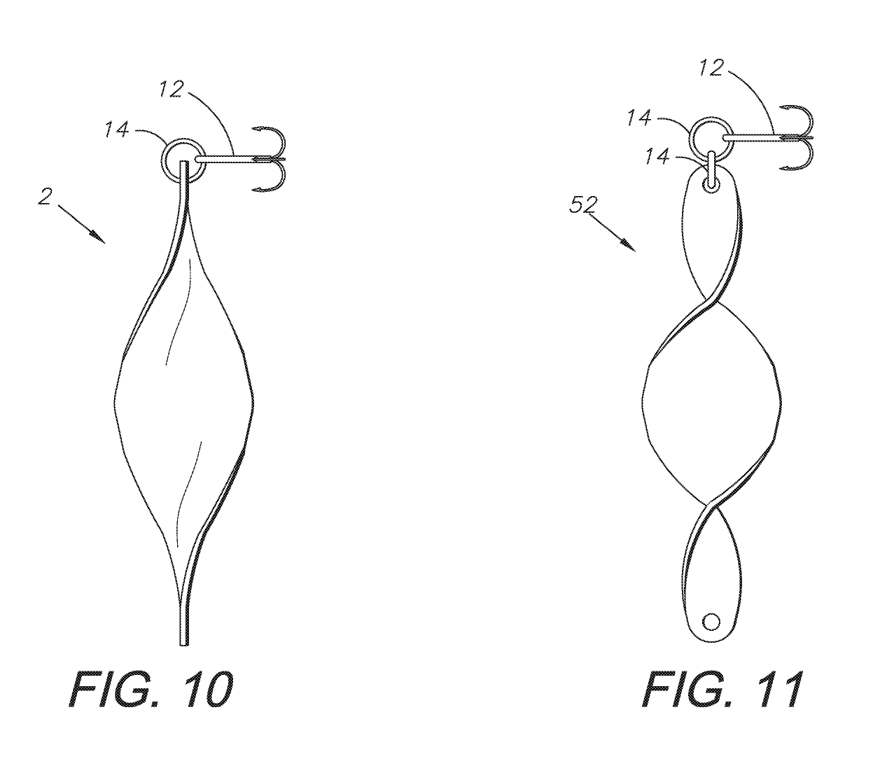

FIG. 10 shows the first embodiment ornamentation 2 connected to a fishing hook 12 using a connection ring 14. Any connector could be used to join the ornamentation 2 to the hook 12. When used as a fishing lure, the ornamentation spins in the water and reflects light in such a way that it attracts fish better than other lures.

FIG. 11 is a similar combination of the second embodiment ornamentation 52 and the hook 12 and connection rings 14. It should be noted that the fishing hook 12 could be any type of hook, including a hook for an earring to be worn for personal decoration, or for a Christmas tree ornament hook, or any type of mounting apparatus. Further, in the case of a fishing hook, bait could also be affixed.

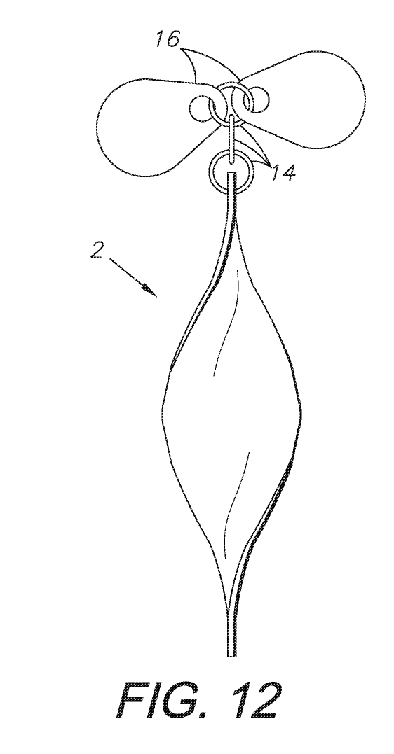

FIG. 12 show the first embodiment ornamentation 2, but includes a pair of leaf elements 16 connected to the mounting hole 10 by at least one connection ring 14. If used as a fishing lure, while the ornamentation 2 is drawn through the water, it will spin in a corkscrew fashion. The leaves 16 will similarly be spun and will flare out away from the ornamentation itself, which will attract fish. A unique sound which attracts fish is also produced when this occurs. The leaves 16 are ideally made of metal and produce a knocking sound against the ornamentation 2, which attracts fish when used as a lure.

### V. Fourth Embodiment Ornamentation 152

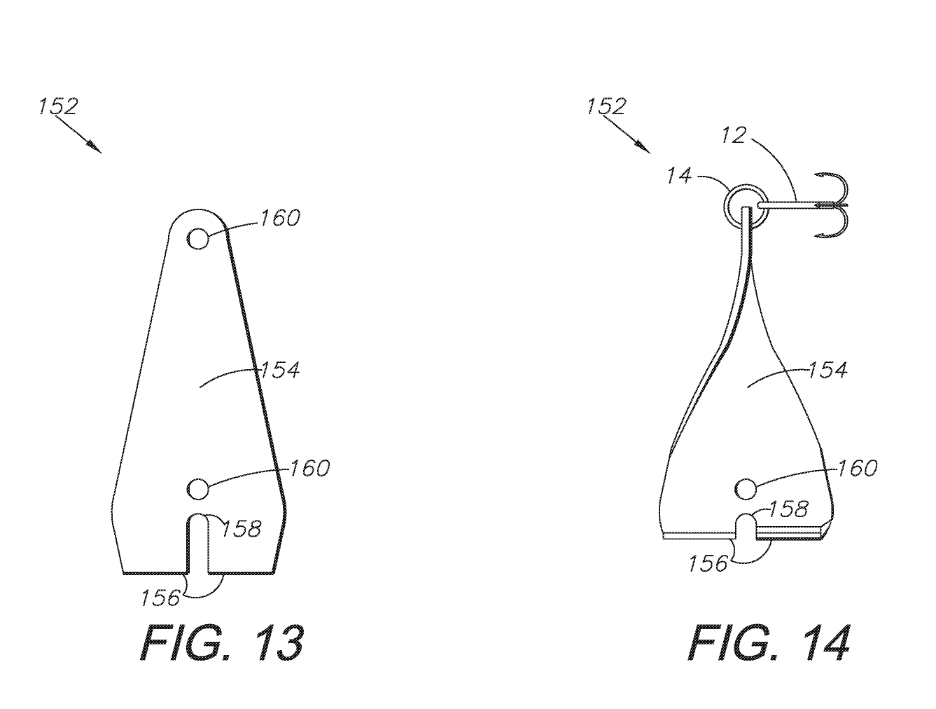

FIGS. 13-16 show a fourth embodiment ornamentation 152. Again, this embodiment begins as a flat blank as shown in FIG. 13 having an upper base portion 154 and two lower leg portions 156 split by a break 158. Two mounting holes 160 are included. FIG. 14 shows the ornamentation 152 after being twisted into a final form, here including a fishing hook 12 connected to the mounting hole 160 by a connection ring 14.

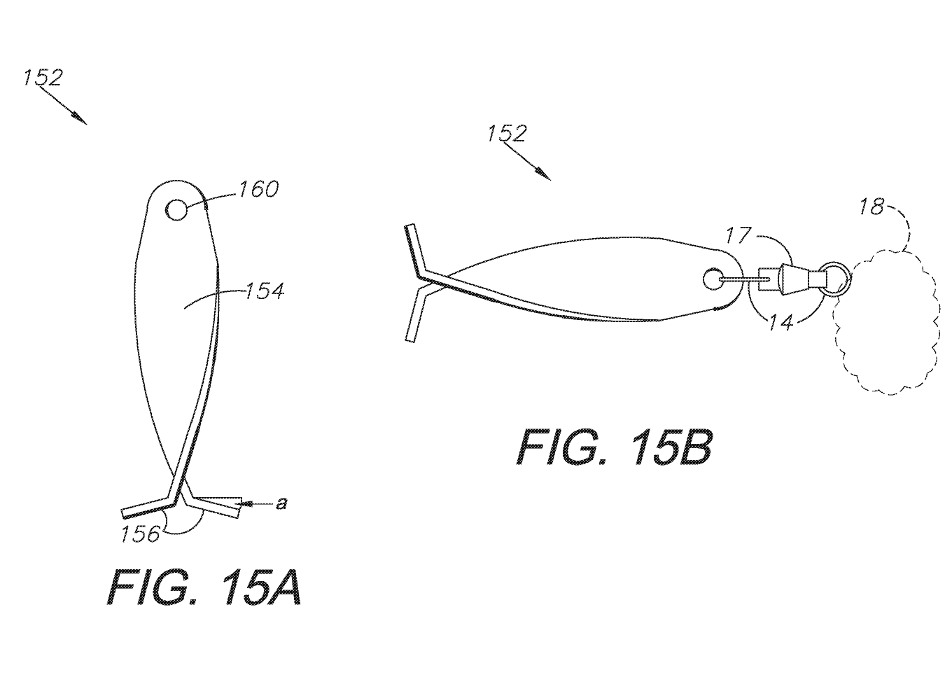

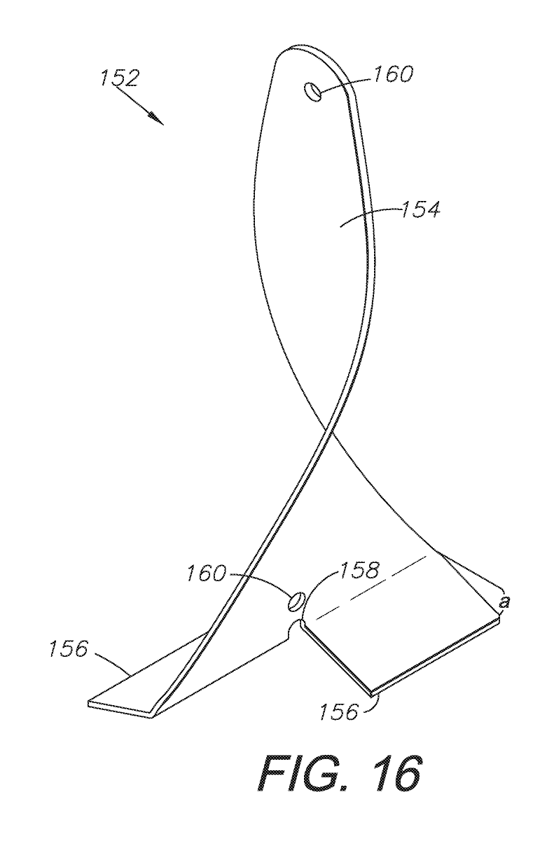

FIG. 15A shows a side elevational view of the ornamentation 152, which also clearly shows the legs 156 bent at an angle “a” away from perpendicular. This angle would be between 0° (completely perpendicular to the upper base portion 152) and 45°. An ideal angle is 22.5°. Further, it is preferably that the twist of the upper base portion 152 continue partially into the bending of the legs 156, whether the upper base portion 152 is twisted 90° (¼ twist) as shown, or 180° (½ twist). FIG. 15B shows how this embodiment is connected to a bait/hook combination 18 or other element via a connection ring 14 and swivel connection 17. This allows free rotation of the ornamentation 152 about the swivel connection 17 when being drawn through the water or when hung as ornamentation. The legs 156 act as tails which catch the wind or the water and cause rotation. FIG. 16 shows another clear view of this embodiment.

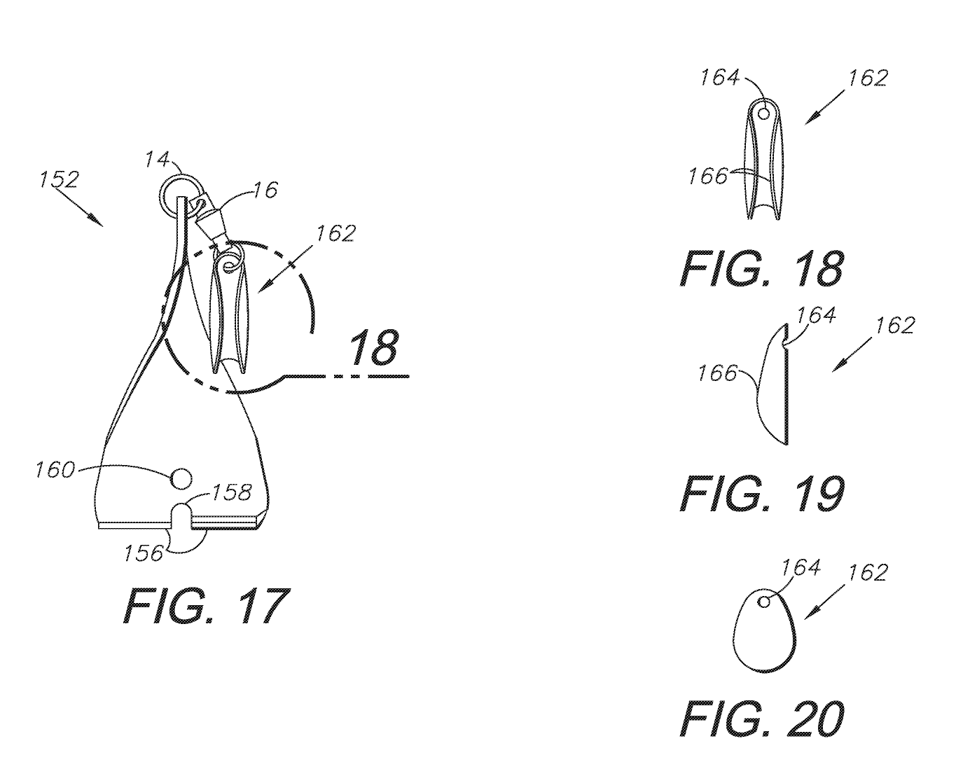

FIG. 17 show the embodiment ornamentation 152 with an additional sound-maker element 162, here shown connected via a connection ring 14 and swivel 16. As the ornamentation spins 152, the sound-maker element 162 knocks against the body of the ornamentation, making a ringing or knocking noise.

FIGS. 18-20 show the sound-maker element 162 in more detail. FIG. 12 shows how the sound-maker element 162 is formed from a flat tear-drop shaped blank with a mounting hole 164. FIGS. 18 and 19 show a front and side view, respectively, of that blank when it is rolled into the sound-maker element which includes a pair of folded up wings 166 which cause the entire element to act like a bell, producing sound which attracts fish if used as a lure, or otherwise creates a pleasant sound if used as a wind chime or other ornamentation.

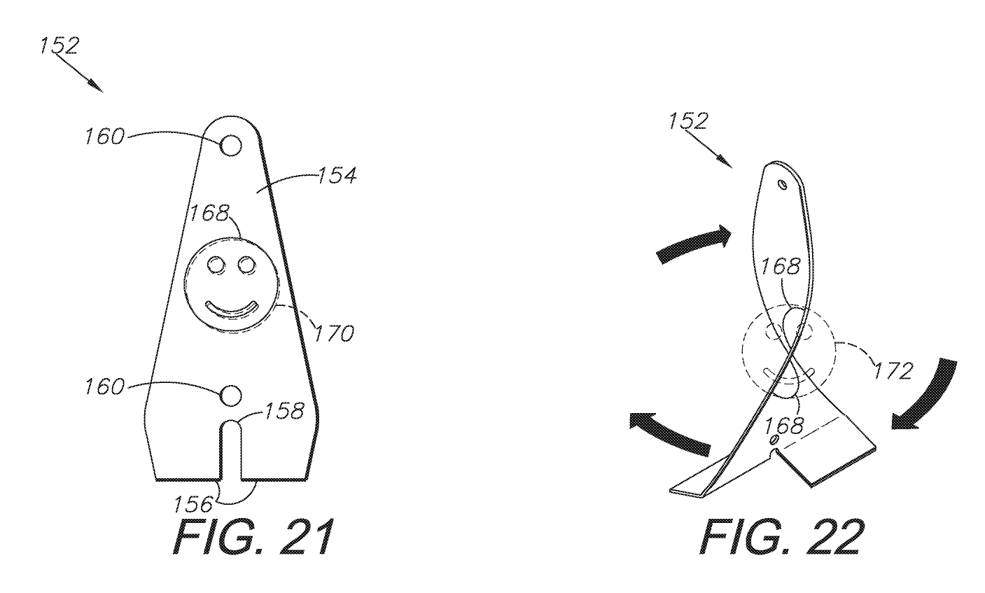

FIGS. 21 and 22 show the embodiment ornamentation 152 when used in conjunction with an image. FIG. 21 shows how a front face image 168 and rear face image 170 can be offset slightly such that when the ornamentation 152 spins about its axis, the resulting image, as shown in FIG. 22, is presented as a three-dimensional flashing hologram 172 to the viewer. This is a result of the speed at which the ornamentation can spin, such as about a swivel connection 17. The image could be any picture, or could be a cut-out portion of the upper base portion 154.

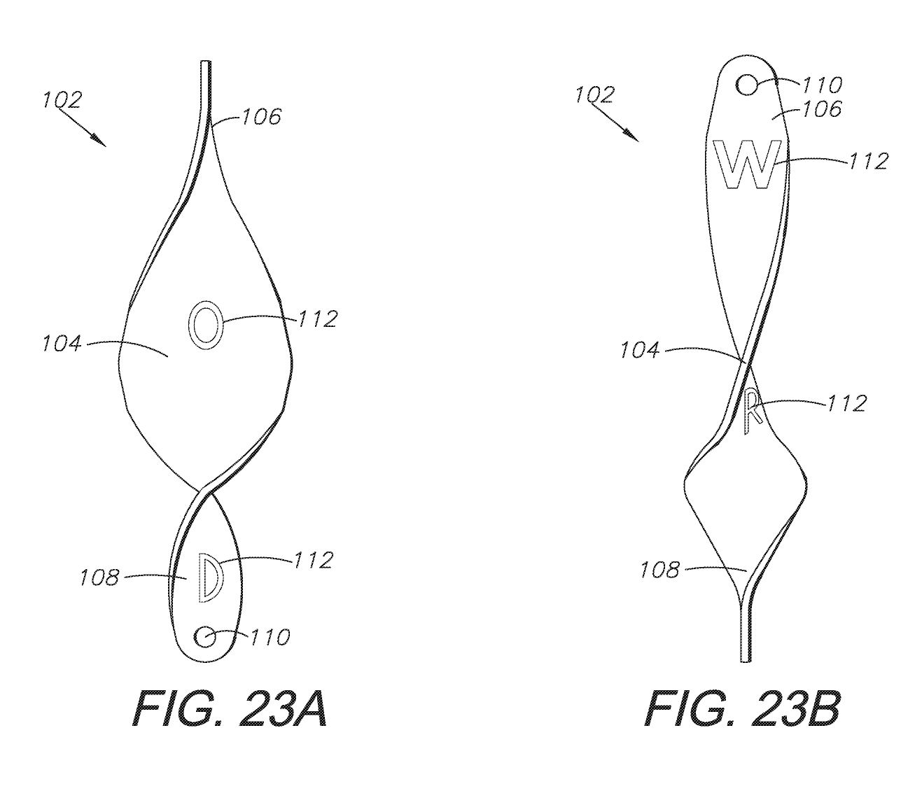

Alternatively, as shown in FIGS. 23A and 23B, the image located on the ornamentation (the third ornamentation embodiment 102), could be a string of letters forming a word. Half of the letters 112 could be on one face of the blank, and half could appear on the other face, such that when the ornamentation 102 spins, the entire word is readable by a viewer. FIGS. 23A and 23B use the third embodiment ornamentation 102, but any of the embodiment ornamentations 2, 52, 102, 152 could be used here.

The lures created using the embodiments of the present invention travel through the water in a straight path and not along an arced path as required in the prior art. The shape and twist of the lures produces increased “flash” and spins absolutely horizontally or vertically (as oriented) on the top of the water, deep in the water, or in a vertical jig. The “flash” produced by the spinning twisting motion of the lures attracts more fish than lures of the prior art.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An ornamentation apparatus comprising:
a main body blank comprising a top end, a bottom end, and a central diameter, wherein said central diameter is a diameter D which is between sixty percent (60%) and seventy-five percent (75%) of a length L, wherein said diameter D is the widest point of said main body blank, and wherein length L is the distance between a top-most point of said top end and a point along a line corresponding with said central diameter D;
a mounting hole located in proximity with said top end; and
wherein said main body blank is configured to be heated and twisted from a first, untwisted orientation to a second, twisted orientation, and wherein said second, twisted orientation promotes the spinning of the ornamentation when in contact with a fluid.

2. The ornamentation apparatus of claim 1, wherein an upper half of said main body blank is twisted ninety degrees (90°) relative to said central diameter and wherein a bottom half of said main body blank is twisted negative ninety degrees (−90°) relative to said central diameter, whereas said central diameter remains untwisted.

3. The ornamentation apparatus of claim 1, wherein an upper half of said main body blank is twisted ninety degrees (180°) relative to said central diameter and wherein a bottom half of said main body blank is twisted negative ninety degrees (−180°) relative to said central diameter, whereas said central diameter remains untwisted.

4. The ornamentation apparatus of claim 1, wherein an upper half of said main body blank is twisted ninety degrees (90°) relative to said central diameter and wherein a bottom half of said main body blank is twisted negative ninety degrees (−180°) relative to said central diameter, whereas said central diameter remains untwisted.

5. The ornamentation apparatus of claim 1, further comprising:
said bottom end comprising a pair of leg tabs separated by a break point;
wherein a first of said pair of legs is bent towards a front face of said main body blank;
wherein a second of said pair of legs is bent towards a rear face of said main body blank; and
wherein each of said pair of legs are bent to an angle between zero degrees (0°) and 45 degrees (45°) from perpendicular with said central diameter.

6. The ornamentation apparatus of claim 5, wherein said pair of legs are bent to an angle of twenty-two and one-half degrees (22.5°) from perpendicular with said central diameter.

7. The ornamentation apparatus of claim 1, further comprising:
a connection ring looped through said mounting hole; and
a hook engaged with said connection ring.

8. The ornamentation apparatus of claim 7, wherein said hook is a fishing hook and said ornamentation apparatus is configured to function as a fishing lure.

9. The ornamentation apparatus of claim 1, further comprising:
a connection ring looped through said mounting hole;
a pair of leaves loosely connected to said connection ring, said pair of leaves configured to move freely about said top end of said main body blank when the ornamentation apparatus rotates; and
wherein said pair of leaves are further configured to produce noise when making contact with said main body blank.

10. The ornamentation apparatus of claim 1, further comprising:
a connection ring looped through said mounting hole;
a rolled sound-maker element loosely connected to said connection ring; and
wherein said rolled sound-maker element is configured to produce noise when making contact with said main body blank.

11. The ornamentation apparatus of claim 10, wherein said rolled sound-maker element is constructed by rolling a tear-drop shaped metal blank such that each of two sides of said metal blank are rolled about a cylindrical object, thereby creating a rounded, rolled shape having a split face formed by said two sides.

12. A method of manufacturing an ornamentation apparatus, the method comprising the steps:
providing a punched-out main body blank comprising a top end, a bottom end, and a central diameter, wherein said central diameter is a diameter D which is between sixty percent (60%) and seventy-five percent (75%) of a length L, wherein said diameter D is the widest point of said main body blank, and wherein length L is the distance between a top-most point of said top end and a point along a line corresponding with said central diameter D;
heating said main body blank;
securing said main body blank bottom end;
twisting said main body blank upper end such that said central diameter remains untwisted, thereby converting said main body blank from a first, flat orientation to a second, twisted orientation; and
wherein said twisted orientation promotes the spinning of the ornamentation when in contact with a fluid.

13. The method of manufacturing of claim 12, further comprising the steps:
securing said main body blank top end; and
twisting said main body blank bottom end such that said central diameter remains untwisted.

14. The method of manufacturing of claim 13, wherein an upper half of said main body blank is twisted ninety degrees (90°) relative to said central diameter and wherein a bottom half of said main body blank is twisted negative ninety degrees (−90°) relative to said central diameter, whereas said central diameter remains untwisted.

15. The method of manufacturing of claim 13, wherein an upper half of said main body blank is twisted ninety degrees (180°) relative to said central diameter and wherein a bottom half of said main body blank is twisted negative ninety degrees (−180°) relative to said central diameter, whereas said central diameter remains untwisted.

16. The method of manufacturing of claim 13, wherein an upper half of said main body blank is twisted ninety degrees (90°) relative to said central diameter and wherein a bottom half of said main body blank is twisted negative ninety degrees (−180°) relative to said central diameter, whereas said central diameter remains untwisted.

17. The method of manufacturing of claim 12, further requiring the steps:
securing said main body blank top end;
said bottom end comprising a pair of leg tabs separated by a break point;
bending a first of said pair of legs towards a front face of said main body blank;
bending a second of said pair of legs towards a rear face of said main body blank; and
wherein each of said pair of legs are bent to an angle between zero degrees (0°) and 45 degrees (45°) from perpendicular with said central diameter.

18. The method of manufacturing of claim 12, further requiring the steps:
connecting a connecting ring to said mounting hole;
rolling a tear-drop shaped metal blank such that each of two sides of said metal blank are rolled about a cylindrical object, thereby creating a rounded, rolled shape having a split face formed by said two sides;
affixing said tear-drop shaped metal blank to said connecting ring; and
generating sound by rotating said main body blank about a vertical central axis, thereby causing said tear-drop shaped metal blank against said main body blank.
